(19) United States
(12) Patent Application Publication
(10) Pub. No.: US 2025/0117090 A1
(43) Pub. Date: Apr. 10, 2025

(54) HAPTIC INPUT DEVICE

(71) Applicant: CK MATERIALS LAB CO., LTD., Ansan-si Gyeonggi-do (KR)

(72) Inventors: Hyeong Jun KIM, Ansan-si Gyeonggi-do (KR); Jeen Gi KIM, Ansan-si Gyeonggi-do (KR); In Sik JEE, Ansan-si Gyeonggi-do (KR)

(73) Assignee: CK MATERIALS LAB CO., LTD., Ansan-si Gyeonggi-do (KR)

(21) Appl. No.: 18/987,423

(22) Filed: Dec. 19, 2024

Related U.S. Application Data
(63) Continuation of application No. PCT/KR2023/009392, filed on Jul. 4, 2023.

(30) Foreign Application Priority Data
Jul. 4, 2022 (KR) 10-2022-0081964
Jul. 3, 2023 (KR) 10-2023-0085959

(51) Int. Cl. G06F 3/01; G06F 3/02

(52) U.S. Cl. CPC G06F 3/016; G06F 3/02

(57) ABSTRACT

Provided is a haptic input device for providing haptic feedback to a user, the haptic input device including a case for providing an internal space, a shaft having an end exposed outside, and another end located in the internal space of the case, a magnetic circuit part positioned on at least one side of the shaft to form a magnetic circuit, an elastic part contacting the other end of the shaft to provide a restoring force to the shaft, and a magnetorheological fluid filled in at least a portion of the internal space.

### CROSS-REFERENCE TO RELATED APPLICATIONS

This application is a continuation of International Application No. PCT/KR2023/009392 filed on Jul. 4, 2023, which claims priority to Korean Patent Application No. 10-2022-0081964 filed on Jul. 4, 2022 and Korean Patent Application No. 10-2023-0085959 filed on Jul. 3, 2023, the entire contents of which are herein incorporated by reference.

### TECHNICAL FIELD

The present invention relates to a haptic input device, and more particularly, to a haptic input device capable of providing haptic feedback in response to user input through the input device.

### BACKGROUND ART

Interfaces capable of enabling natural and easy use and facilitating data exchange when using various electronic and mechanical devices are attracting significant interest. Computer input devices such as keyboards, mice, touchpads, touch pens, and tablets enable input for applications and cursor control on displays.

Some interface devices may provide haptic feedback to users. For example, joysticks, mice, game pads, steering wheels, or other devices may provide haptic feedback based on events or interactions occurring on a display in games or other application programs.

Meanwhile, input methods based on touchpads or voice recognition are becoming more common to provide a more convenient interface for users. Nevertheless, button-type input devices, such as keyboards and mice, remain the most widely used means of input. However, these button-type devices only provide the repulsive force of an elastic component, such as a spring, as feedback to an external force applied by a user. In other words, these devices provide the same haptic feedback, rather than providing various forms of feedback.

### DETAILED DESCRIPTION OF THE INVENTION

### Technical Problem

The present invention provides a haptic input device capable of providing haptic feedback to a user in various forms.

The present invention also provides a haptic input device capable of achieving a small size and thickness and of operating with low energy.

However, the above description is an example, and the scope of the present invention is not limited thereto.

### Technical Solution

According to an aspect of the present invention, there is provided a haptic input device for providing haptic feedback to a user, the haptic input device including a case for providing an internal space, a shaft having an end exposed outside, and another end located in the internal space of the case, a magnetic circuit part positioned on at least one side of the shaft to form a magnetic circuit, an elastic part contacting the other end of the shaft to provide a restoring force to the shaft, and a magnetorheological fluid filled in at least a portion of the internal space.

The haptic input device may further include a controller for controlling the magnetic circuit formed by the magnetic circuit part.

The case may include a first case positioned on top and having a shaft passage hole through which the shaft passes, and a second case positioned on bottom to provide the internal space where the magnetorheological fluid is accommodated.

The second case may include an accommodation part where the magnetorheological fluid and the elastic part are accommodated.

The pressers may include at least a magnetic portion, the magnetic circuit part may be provided in an XY plane direction, and an end and another end of the magnetic circuit part may be supported on the accommodation part and the second case and positioned in the internal space.

The controller may include a control circuit part, and a control terminal for transmitting power to the control circuit part, the control circuit part may be positioned in the internal space, and at least a portion of the control terminal may be exposed outside the case.

A knob may be connected to the end of the shaft.

A switch may be further positioned in the accommodation part, and a pusher for pushing the switch may protrude from the other end of the shaft.

The other end of the shaft may include pressers for pressing at least the elastic part, and a fluidic part serving as a space where the magnetorheological fluid is movable may be formed between the pressers.

Based on the XY plane direction, magnetic flux lines may be formed from a first pole of the magnetic circuit part through the pressers to a second pole of the magnetic circuit part.

A stopper may be provided on side surfaces of the shaft to restrict an operation range of the shaft to a lower surface of the shaft passage hole of the first case.

The haptic input device may further include a yoke positioned in the internal space of the second case to provide a second internal space.

The magnetorheological fluid may be filled in the second internal space of the yoke, and the second internal space may have an upper portion sealed by the first case and a lower portion sealed by the second case.

The magnetic circuit part may be positioned in a space between the yoke and the second case.

The elastic part may be positioned in the second internal space, and the other end of the shaft may be inserted into the elastic part.

A stopper may be further provided on side surfaces of the shaft to have a width corresponding to a width of the second internal space, and inner side surfaces of the yoke may guide the shaft to operate along a Z-axis direction in the second internal space.

Side parts may further extend downward from ends of the stopper.

The side parts may include at least a magnetic portion and, based on the Z-axis direction, magnetic flux lines may be formed from an upper portion of the magnetic circuit part through the stopper and the side parts to a lower portion of the magnetic circuit part.

A stopper may be provided on side surfaces of the shaft, and the haptic input device may further include a protector positioned under the stopper to surround an outer circumference of the shaft, and positioned on the accommodation part to prevent the magnetorheological fluid from leaking outside the accommodation part.

The protector may be made of an elastic material, and the stopper may press the protector and the shaft may move downward when a force is applied downward to the end of the shaft.

A plurality of elastic parts may be positioned in the accommodation part, parallel to an XY plane direction.

The magnetic circuit part may include first and second poles for generating a magnetic field, a first core fitted to the first pole, and a second core fitted to the second pole.

The magnetic circuit part may interconnect outer sides of the first and second cores, and further include a magnetic frame surrounding outer sides of the first and second poles.

A lower surface of the magnetic frame may be supported on internal recesses of the case.

The magnetic frame may include at least a magnetic portion and, based on the Z-axis direction, magnetic flux lines may be formed from an upper portion of the magnetic circuit part through the shaft and the magnetic frame to a lower portion of the magnetic circuit part.

### Advantageous Effects

According to the present invention configured as described above, the haptic input device may provide haptic feedback to a user in various forms.

In addition, according to the present invention, the haptic input device may achieve a small size and thickness and operate with low energy.

However, the scope of the present invention is not limited to the above effects.

### DESCRIPTION OF THE DRAWINGS

FIG. 1 is a perspective view of a haptic input device according to a first embodiment of the present invention.

FIG. 2 is a cross-sectional view of the haptic input device according to the first embodiment of the present invention.

FIG. 3 is an exploded perspective view of the haptic input device according to the first embodiment of the present invention.

FIG. 4 is a schematic view showing operation of the haptic input device according to the first embodiment of the present invention.

FIG. 5 is a schematic view showing magnetic flux lines between a magnetic circuit part and a shaft of the haptic input device according to the first embodiment of the present invention.

FIG. 6 is a perspective view of a haptic input device according to a second embodiment of the present invention.

FIG. 7 is a cross-sectional view of the haptic input device according to the second embodiment of the present invention.

FIG. 8 is an exploded perspective view of the haptic input device according to the second embodiment of the present invention.

FIG. 9 is a schematic view showing operation of the haptic input device according to the second embodiment of the present invention.

FIG. 10 is a schematic view of a magnetic circuit of the haptic input device according to the second embodiment of the present invention.

FIG. 11 is a perspective view of a haptic input device according to a third embodiment of the present invention.

FIG. 12 is a cross-sectional view of the haptic input device according to the third embodiment of the present invention.

FIG. 13 is an exploded perspective view of the haptic input device according to the third embodiment of the present invention.

FIG. 14 is another cross-sectional view of the haptic input device according to the third embodiment of the present invention.

FIG. 15 is a schematic view showing operation of the haptic input device according to the third embodiment of the present invention.

FIG. 16 is a no-load test graph of a haptic input device according to a test example of the present invention.

FIG. 17 is a load test graph of a haptic input device according to a test example of the present invention.

### EXPLANATION OF REFERENCE NUMERALS

100, 200, 300: Haptic input device
110, 210, 310: Case
111, 211, 311: First case
115, 215, 315: Second case
117, 317: Accommodation part
120, 220, 320: Shaft
130, 230, 330: Magnetic circuit part
140, 240, 340: Elastic part
160, 260, 360: Controller
170, 370: Knob
180, 280: Switch
250: Yoke
390: Protector
M: Magnetorheological fluid
R1, R5, R6: Internal space of second case
R2, R7: Accommodation space of accommodation part
R3: Central space of magnetic circuit part
R4: Second internal space of yoke

### DETAILED DESCRIPTION OF THE INVENTION

The following detailed description of the invention will be made with reference to the accompanying drawings illustrating specific embodiments of the invention by way of example. These embodiments will be described in sufficient detail such that the invention may be carried out by one of ordinary skill in the art. It should be understood that various embodiments of the invention are different but do not need to be mutually exclusive. For example, a specific shape, structure, or characteristic described herein in relation to an embodiment may be implemented as another embodiment without departing from the scope of the invention. In addition, it should be understood that positions or arrangements of individual elements in each disclosed embodiment may be changed without departing from the scope of the invention. Therefore, the following detailed description should not be construed as being restrictive and, if appropriately described, the scope of the invention is defined only by the appended claims and equivalents thereof. In the drawings, like reference numerals denote like functions, and lengths, areas, thicknesses, and shapes may be exaggerated for convenience's sake.

Hereinafter, the present invention will be described in detail by explaining embodiments of the invention with reference to the attached drawings, such that one of ordinary skill in the art may easily carry out the invention.

A haptic input device 100 or 200 of the present invention may provide haptic feedback when a user performs input operation by applying an external force. The haptic input device 100 or 200 of the present invention may include any input device which is pressed by a user to perform input operation, e.g., a keyboard, a mouse, or buttons.

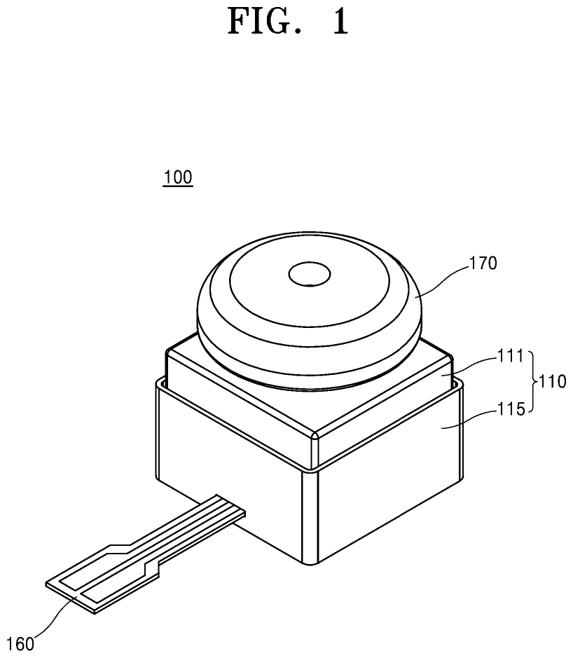

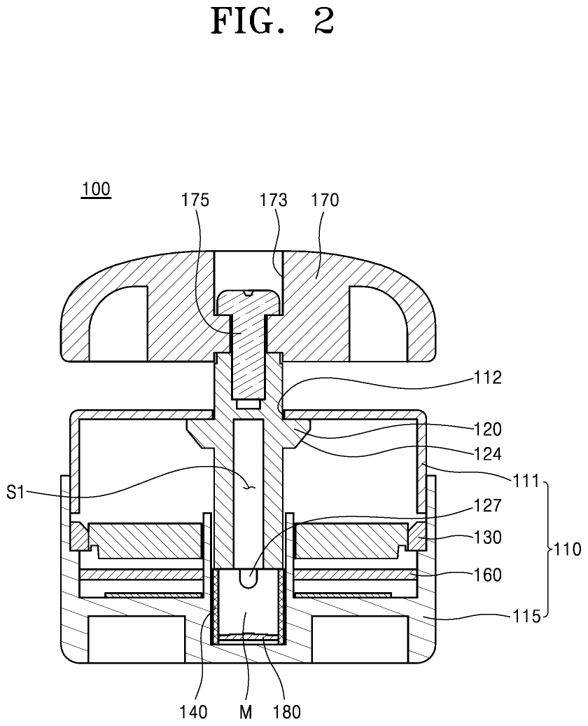

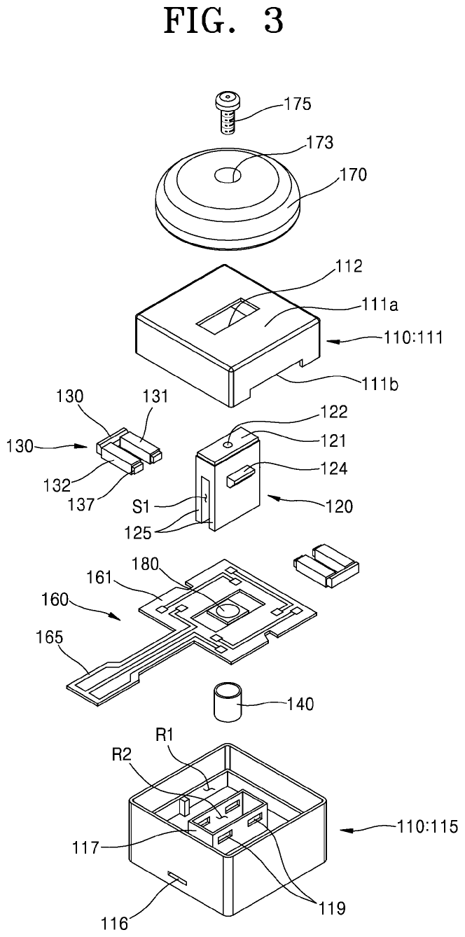

FIG. 1 is a perspective view of a haptic input device 100 according to a first embodiment of the present invention. FIG. 2 is a cross-sectional view of the haptic input device 100 according to the first embodiment of the present invention. FIG. 3 is an exploded perspective view of the haptic input device 100 according to the first embodiment of the present invention.

Referring to FIGS. 1 to 3, the haptic input device 100 according to the first embodiment of the present invention may include a case 110: 111 and 115, a shaft 120, a magnetic circuit part 130, an elastic part 140, and a magnetorheological fluid M, and further include a controller 160, a knob 170, and a switch 180.

The case 110: 111 and 115 is a housing of the haptic input device 100, and may provide an internal space R1 for storing other components. The case 110 may include a first case 111 positioned on the top, and a second case 115 positioned on the bottom. The first and second cases 111 and 115 may be connected or fitted together to form the internal space R1. The case 110 may be made of a material such as stainless steel (SUS) or polycarbonate (PC).

The first case 111 may be provided in a roughly cuboid shape with an open bottom. A shaft passage hole 112 may be formed in an upper surface 111a of the first case 111 to allow the shaft 120 to move vertically along the Z-axis direction. Side surfaces 111b of the first case 111 may have a shape fitted to the second case 115. As such, the internal space R1 may be closed except for the shaft passage hole 112.

The second case 115 may be provided in a roughly cuboid shape with an open top. A control hole 116 through which a control terminal 165 of the controller 160 may pass may be formed in a side surface of the second case 115.

An accommodation part 117 may be provided in the internal space R1 of the second case 115. The accommodation part 117 may be provided in a tube or column shape with an open top. When the lower surface of the accommodation part 117 is replaced by the inner lower surface of the second case 115, the accommodation part 117 may be provided in a tube or column shape with an open top and bottom.

The accommodation part 117 may provide an accommodation space R2 in the same direction as an extension direction of the shaft 120 (i.e., the Z-axis direction). The accommodation space R2 of the accommodation part 117 may be provided to have a shape, i.e., an inner diameter, corresponding to the outer diameter of the shaft 120. Therefore, when the shaft 120 operates along the Z-axis direction, the shaft 120 may operate in the accommodation space R2 without any axial deviation. The accommodation space R2 may have a height less than a Z-axis direction length of a portion of the shaft 120 positioned in the internal space R1 of the case 110.

The magnetorheological fluid M may be filled in the accommodation space R2 of the accommodation part 117. The magnetorheological fluid M includes magnetic particles, and a fluidic medium, e.g., oil or water, where the magnetic particles are dispersed. The magnetorheological fluid M may be sealed inside the accommodation space R2 by the shaft 120. In addition, the elastic part 140 may be positioned in the accommodation space R2 of the accommodation part 117. Optionally, the switch 180 may be further positioned in the accommodation space R2 of the accommodation part 117.

The shaft 120 may be configured to directly provide haptic feedback as a repulsive force to a user in response to the application of an external force. The shaft 120 may extend roughly in the Z-axis direction. The shaft 120 may have an end (or upper end) exposed outside the case 110, and another end (or lower end) located in the internal space R1 of the case 110. The end (or upper end) of the shaft 120 may be exposed outside the case 110 through the shaft passage hole 112. The shaft passage hole 112 and the shaft 120 may have corresponding horizontal cross-sectional shapes, such that the internal space R1 of the case 110 is closed when the shaft 120 passes upward through the shaft passage hole 112 in the Z-axis direction. For a tight seal, a sealing member (not shown) may be further provided around the shaft passage hole 112 and the shaft 120.

Optionally, the knob 170 may be connected to the end of the shaft 120. The knob 170 may serve to expand the surface area where the user touches the haptic input device 100, and to more effectively provide the haptic feedback to the user. A connection hole 173 may be formed in the knob 170 so as to be connected to a fastening hole 122 formed in an upper surface 121 of the shaft 120. A fastening means 175 such as a screw or bolt may be assembled into the connection hole 173 and the fastening hole 122 to fasten the shaft 120 and the knob 170 together.

A stopper 124 may be provided on side surfaces of the shaft 120. The stopper 124 may protrude in a lateral direction of the shaft 120 (i.e., the XY plane direction). The stopper 124 may restrict the upper limit of an operation range of the shaft 120 to prevent the shaft 120 from exiting through the shaft passage hole 112. The stopper 124 may protrude in the lateral direction of the shaft 120 so as not to enter the accommodation space R2. Although the stopper 124 may be provided on both side surfaces of the shaft 120 to contact the lower surface of the shaft passage hole 112 [or the inside of the upper surface 111a of the first case 111], the stopper 124 may also be provided on only one side surface of the shaft 120 as long as the shaft 120 is held by the lower surface of the shaft passage hole 112 [or the inside of the upper surface 111a of the first case 111].

The other end (or lower end) of the shaft 120 may include pressers 125 for pressing at least the elastic part 140. In addition, a fluidic part S1 serving as a space where the magnetorheological fluid M is movable may be formed in the other end of the shaft 120. That is, the other end of the shaft 120 excluding the space where the fluidic part S1 is formed may be provided as the pressers 125.

The pressers 125 may correspond to the edge of the elastic part 140 to press the elastic part 140. For example, when the elastic part 140 is in the shape of a spring, the pressers 125 may have a shape corresponding to at least the edge of the spring so as to press the edge. Although it is shown in this specification that a horizontal cross-section (i.e., a section in the XY plane) of the pressers 125 has an ‘H’ shape, the pressers 125 are not limited to any shape as long as the fluidic part S1 may be provided and the elastic part 140 may be pressed.

The pressers 125 may be portions that are substantially subjected to shear force, resistance force, torque, or changes in stiffness during Z-axis direction operation due to the formation of magnetic chains by the magnetorheological fluid M. To form the magnetic chains more effectively, the shaft 120 or the pressers 125 may include a magnetic portion. When the shaft 120 or the pressers 125 include a magnetic portion, it means that the entirety or only a portion of the shaft 120 or the pressers 125 are made of a magnetic material. The magnetic material may include iron, nickel, cobalt, ferrite (Fe₃O₄), alloys thereof, or metals that are nitrided, oxidized, carbonized, or siliconized. According to an embodiment, the shaft 120 may be made of a material such as steel plate cold commercial (SPCC).

A pusher 127 may be further provided on the other end (or lower end) of the shaft 120. The pusher 127 is provided to push the switch 180 positioned on the bottom surface of the accommodation part 117, without direct contact with the elastic part 140 when the pressers 125 press the elastic part 140. The pusher 127 may protrude downward from a region in the XY plane, which is different from that of the pressers 125. From another perspective, when the elastic part 140 is provided as a hollow spring, the pusher 127 may protrude into the hollow space of the elastic part 140.

The magnetic circuit part 130 may form a magnetic circuit for changing the behavior of the magnetorheological fluid M. The magnetic circuit part 130 may generate a magnetic field in the magnetic circuit based on a control signal or control power received from the controller 160. The magnetic circuit part 130 may use a means capable of controlling the direction of the magnetic field. The magnetic circuit part 130 may include a solenoid coil to change the direction of the magnetic field by controlling the direction of the flow of current.

The magnetic circuit part 130 may be positioned on at least one side of the shaft 120 in the internal space R1 of the case 110. The magnetic circuit part 130 may be provided along the XY plane direction to form magnetic flux lines in the XY plane direction from a side surface of the shaft 120. Although it is shown in this specification that two magnetic circuit parts 130 are spaced apart from each other on left and right sides of the shaft 120, the magnetic circuit part 130 may be selectively positioned on only one side of the shaft 120. Alternatively, the magnetic circuit part 130 may be further positioned on a side other than the left and right sides of the shaft 120.

Ends 137 of the magnetic circuit part 130 may be supported by the accommodation part 117, and another end 135 thereof may be supported on the second case 115. Specifically, the ends 137 of the magnetic circuit part 130 may be fitted into and supported by support holes 119 formed in a side wall of the accommodation part 117. The other end 135 may be supported on a certain recess formed in the inner side wall of the second case 115, or attached to and supported by the inner side wall of the second case 115.

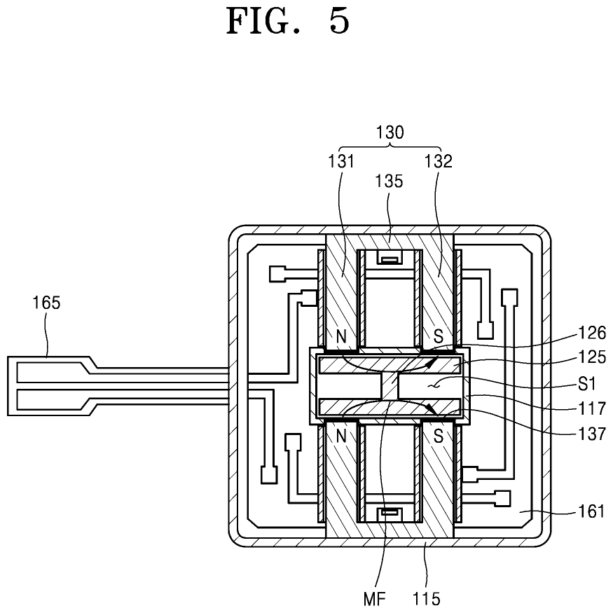

A first pole 131 and a second pole 132 of the magnetic circuit part 130 may be provided as a magnet. For example, the first and second poles 131 and 132 may be provided include a coil and a solenoid electromagnet. Alternatively, the magnetic circuit part 130 may be provided to include a permanent magnet. The first and second poles 131 and 132 may be spaced apart from each other, parallel to a horizontal plane direction (i.e., the XY plane direction). To form magnetic flux lines MF in a closed-loop shape [see FIG. 5], the first and second poles 131 and 132 may have different polarities. For example, the first pole 131 may be an N pole, and the second pole 132 may be an S pole.

The other end 135 of the magnetic circuit part 130 may be electrically connected to the controller 160 to receive power. The other end 135 of the magnetic circuit part 130 may be provided as a core of the first and second poles 131 and 132. The ends 137 of the magnetic circuit part 130 may be fitted into the support holes 119 of the accommodation part 117, positioning the magnetic circuit part 130 in the horizontal plane direction and, simultaneously, sealing the magnetorheological fluid M inside the accommodation part 117 by blocking the support holes 119.

Like the pressers 125, the ends 137 of the magnetic circuit part 130 may include a magnetic portion. As such, the magnetic flux lines MF may be formed more effectively along the first and second poles 131 and 132, the ends 137, and the shaft 120 [or the pressers 125].

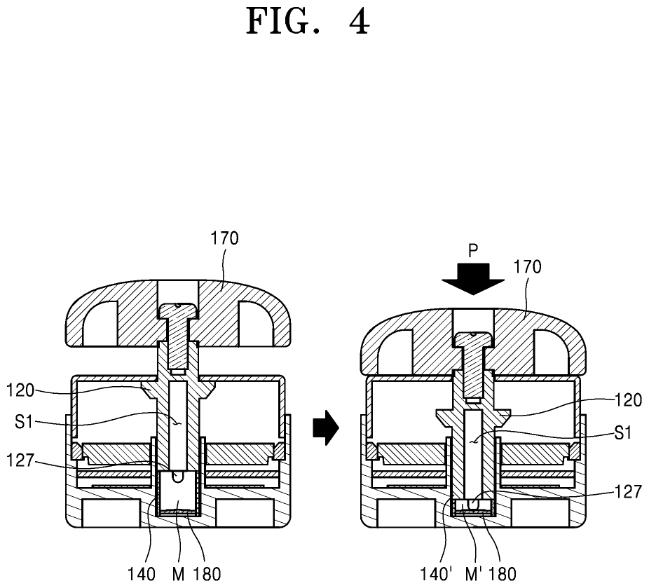

The elastic part 140 may be positioned in the accommodation space R2 of the accommodation part 117. The elastic part 140 may contact and support a lower portion of the shaft 120 [or the pressers 125]. The elastic part 140 may provide haptic feedback based on a resistance force when the user applies an external force P [see FIG. 4] to an upper end of the shaft 120 or the knob 170, and provide a restoring force to return the shaft 120 upward when the user releases the external force P. The elastic part 140 may be provided in the form of a coil spring, or provided as a known rubber dome or another elastic means. For example, the material of the elastic part 140 may include piano wire such as SWP.

The controller 160 may be provided to control the magnetic circuit formed by the magnetic circuit part 130. The controller 160 may include a control circuit part 161 for substantially transmitting the control signal or control power to the magnetic circuit part 130, and a control terminal 165 for receiving power from an external power supply means (not shown) and transmitting the power to the control circuit part 161. The control circuit part 161 may be positioned in the internal space R1 of the case 110. The control terminal 165 may extend from the control circuit part 161, pass through the control hole 116, and be exposed outside the case 110.

The switch 180 may be positioned in the accommodation part 117. The switch 180 may be pushed by the pusher 127 of the shaft 120 to transmit an input signal to an apparatus connected to the haptic input device 100. The signal from the switch 180 may also be transmitted to the controller 160. The controller 160 may control the formation of the magnetic circuit by the magnetic circuit part 130 by further considering the input signal from the switch 180.

FIG. 4 is a schematic view showing operation of the haptic input device 100 according to the first embodiment of the present invention. FIG. 5 is a schematic view showing the magnetic flux lines MF between the magnetic circuit part 130 and the shaft 120 of the haptic input device 100 according to the first embodiment of the present invention.

Referring to FIGS. 4 and 5, the magnetic circuit part 130 may be provided in the horizontal plane direction (i.e., the XY plane direction), and the first and second poles 131 and 132 may be wound with coils to have opposite polarities. As such, the magnetic circuit may also be formed in the horizontal plane direction to correspond to the formation direction of the magnetic circuit part 130. The pressers 125, which may be made of a magnetic material, may also contribute to the formation of the magnetic flux lines MF in the horizontal plane direction. As shown in FIG. 5, the magnetic flux lines MF may form magnetic loops along the first pole 131—the pressers 125—the second pole 132.

As shown in FIG. 4, when the user applies the external force P to push the shaft 120 [or the knob 170], the shaft 120 presses the elastic part 140. When no magnetic field is applied and no magnetic flux lines MF are formed, the elastic part 140 may be pressed (140→140′) to provide the user with a repulsive force corresponding to its elastic force.

When a magnetic field is applied and the magnetic flux lines MF are formed, the magnetic particles in the magnetorheological fluid M may form magnetic chains (M→M′) in the direction of the magnetic flux lines MF. The magnetic chains may be formed roughly from the inner side wall of the accommodation part 117 where the magnetorheological fluid M is accommodated, to a side of the shaft 120. Alternatively, the magnetic chains may be formed from a side of the shaft 120 [or a side of the pressers 125] to the inner side wall of the accommodation part 117 in the fluidic part S1 of the shaft 120. Due to the formation of the magnetic chains by the magnetic flux lines MF, resistance may be applied to the Z-axis direction operation of the shaft 120. That is, the magnetic chains may be formed in the horizontal plane direction (i.e., the XY plane direction) perpendicular to the operation direction of the shaft 120, and resistance may be applied in the Z-axis operation direction of the shaft 120. The resistance force applied during Z-axis direction operation of the shaft 120 may vary depending on the strength of the magnetic field, the bonding force of the magnetic chains, or the like. The user may be provided with haptic feedback based on the form, pattern, or strength of resistance.

When the user releases the external force P and the magnetic circuit part 130 also releases the magnetic field, the shaft 120 may return upward due to the restoring force of the elastic part 140.

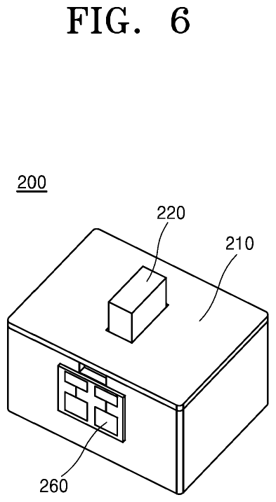

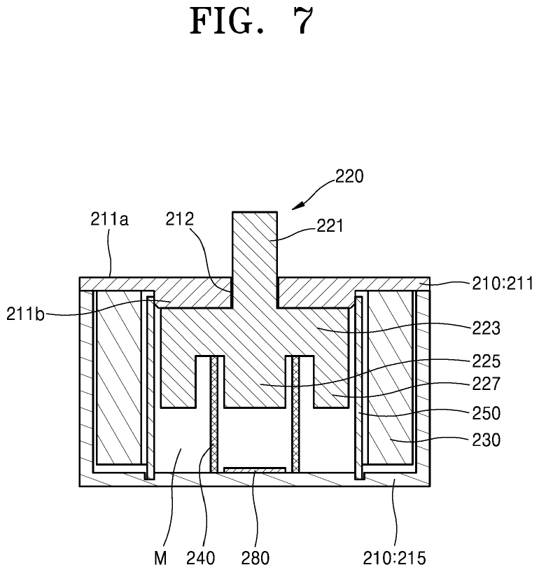

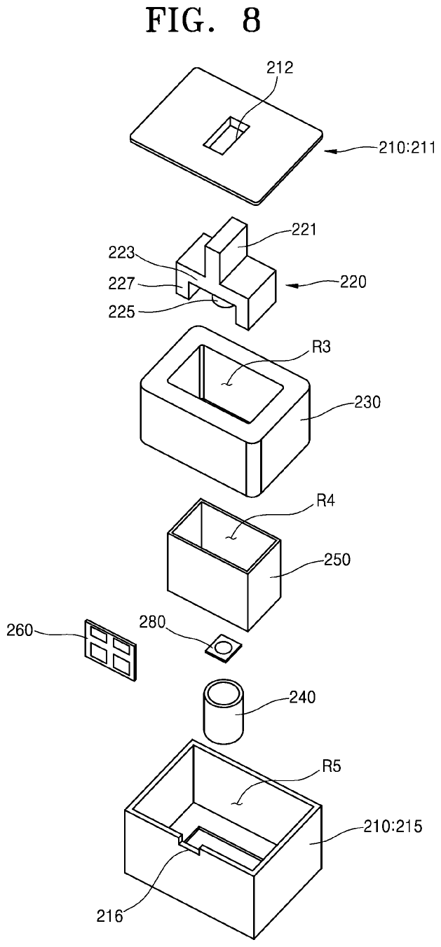

FIG. 6 is a perspective view of a haptic input device 200 according to a second embodiment of the present invention. FIG. 7 is a cross-sectional view of the haptic input device 200 according to the second embodiment of the present invention. FIG. 8 is an exploded perspective view of the haptic input device 200 according to the second embodiment of the present invention. Only elements that differ from those in the first embodiment of FIGS. 1 to 5 will be described below, and the same elements will not be repeated. The elements denoted by reference numerals 2XX in the second embodiment correspond to those denoted by reference numerals 1XX in the first embodiment. Unless stated otherwise, the descriptions of the elements provided above in relation to FIGS. 1 to 5 also apply to FIGS. 6 to 8.

Referring to FIGS. 6 to 8, the haptic input device 200 according to the second embodiment of the present invention may include a case 210: 211 and 215, a shaft 220, a magnetic circuit part 230, an elastic part 240, a yoke 250, and a magnetorheological fluid M, and further include a controller 260 and a switch 280. The haptic input device 200 of the second embodiment is designed to reduce the size and simplify the structure compared to the haptic input device 100 of the first embodiment.

The case 210: 211 and 215 is a housing of the haptic input device 200, and may provide an internal space R5 for storing other components. A first case 211 may be provided in a roughly flat panel shape with a shaft passage hole 212. A second case 215 may be provided in a roughly cuboid shape with an open top. A connection hole 216 through which the controller 260 may be electrically connected to the magnetic circuit part 230 may be formed in a side surface of the second case 215.

The magnetic circuit part 230 may be positioned in the internal space R5 of the second case 215. The magnetic circuit part 230 may be provided to surround and correspond to the inner side surfaces of the second case 215. The magnetic circuit part 230 may be provided in a barrel shape to have a central space R3. The magnetic circuit part 230 may be provided as a coil wound along the inner side surfaces of the second case 215.

The haptic input device 200 of the second embodiment may further include the yoke 250. The yoke 250 may be positioned in the internal space R5 of the second case 215. Specifically, the yoke 250 may be positioned in the central space R3 of the magnetic circuit part 230. The yoke 250 may provide a second internal space R4. The yoke 250 may be provided to surround and correspond to the inner side surfaces of the magnetic circuit part 230. The yoke 250 may be provided in a tube or column shape to have the second internal space R4. The yoke 250 may be made of the same material as the case 210, such as SUS or PC.

The yoke 250 may provide the second internal space R4 in the same direction as the extension direction of the shaft 220 (i.e., the Z-axis direction). The second internal space R4 of the yoke 250 may be provided to have a shape, i.e., an inner diameter, corresponding to the outer diameter of the shaft 220. Therefore, when the shaft 220 operates along the Z-axis direction, the shaft 220 may operate in the second internal space R4 without any axial deviation.

The magnetorheological fluid M may be filled in the second internal space R4. To seal the magnetorheological fluid M, the second internal space R4 may have a height corresponding to the height of the second case 215. The internal space R5 of the second case 215 may be partitioned by the yoke 250 into a space where the magnetic circuit part 230 is positioned and the second internal space R4 where the magnetorheological fluid M is positioned. Therefore, magnetic particles of the magnetorheological fluid M may be prevented from directly attaching to the magnetic circuit part 230.

The magnetic circuit part 230 and the yoke 250 may be sequentially positioned in the internal space R5 of the second case 215, the magnetorheological fluid M, the elastic part 240, and the switch 280 may be positioned in the second internal space R4 of the yoke 250, and then the shaft 220 may be inserted into the elastic part 240. The first case 211 may be fitted onto the second case 215 to seal upper portions of the internal space R5 and the second internal space R4. An upper portion 211a of the first case 211 may contact an upper portion of the yoke 250 and an upper edge of the second case 215 to seal the space where the magnetic circuit part 230 is positioned. A lower portion 211b of the first case 211 may contact the upper portion of the yoke 250 to seal the second internal space R4.

An upper end 221 of the shaft 220 may be exposed outside the case 210 through the shaft passage hole 212, and a lower end 225 may be inserted into the elastic part 240. A stopper 223 may be provided on side surfaces of the shaft 220. The stopper 223 may protrude in a lateral direction of the shaft 220 (i.e., the XY plane direction). The stopper 223 may restrict the upper limit of an operation range of the shaft 220 to prevent the shaft 220 from exiting through the shaft passage hole 212. The stopper 223 may protrude in the lateral direction of the shaft 220 so as not to enter the elastic part 240. Although the stopper 223 may be provided on both side surfaces of the shaft 220 to contact the lower surface of the shaft passage hole 212 [or the inside of the lower portion 211b of the first case 211], the stopper 223 may also be provided on only one side surface of the shaft 220 as long as the shaft 220 is held by the lower surface of the shaft passage hole 212 [or the inside of the lower portion 211b of the first case 211].

The stopper 223 may be provided to have a width corresponding to the width of the second internal space R4. As such, the shaft 220 may smoothly operate along the Z-axis direction in the second internal space R4 without any axial deviation. Side parts 227 may further extend downward from both ends of the stopper 223. The side parts 227 may be positioned outside the elastic part 240, and the lower end 225 may be inserted into the elastic part 240. As such, the elastic part 240 may be pressed by the lower surface of the stopper 223. That is, a portion of the lower surface of the stopper 223 other than those from which the lower end 225 and the side parts 227 extend may contact the elastic part 240. The inner side surfaces of the yoke 250 may guide the shaft 220 to operate along the Z-axis direction in the second internal space R4 without deviating in the XY plane direction.

The lower end 225 and the side parts 227 of the shaft 220 may be portions that are substantially subjected to shear force, resistance force, torque, or changes in stiffness during Z-axis direction operation due to the formation of magnetic chains in the magnetorheological fluid M. To form the magnetic chains more effectively, at least one of the lower end 225 and the side parts 227 of the shaft 220 may include a magnetic portion.

The controller 260 may be provided to control a magnetic circuit formed by the magnetic circuit part 230. The controller 260 may be positioned on an outer surface of the case 210, and electrically connected to the magnetic circuit part 230 through the connection hole 216.

Optionally, a pusher (not shown) capable of pushing the switch 280 may be further provided on the lower end 225 of the shaft 220.

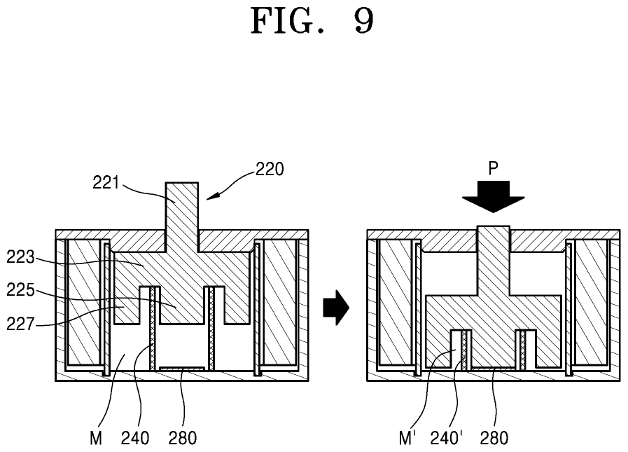

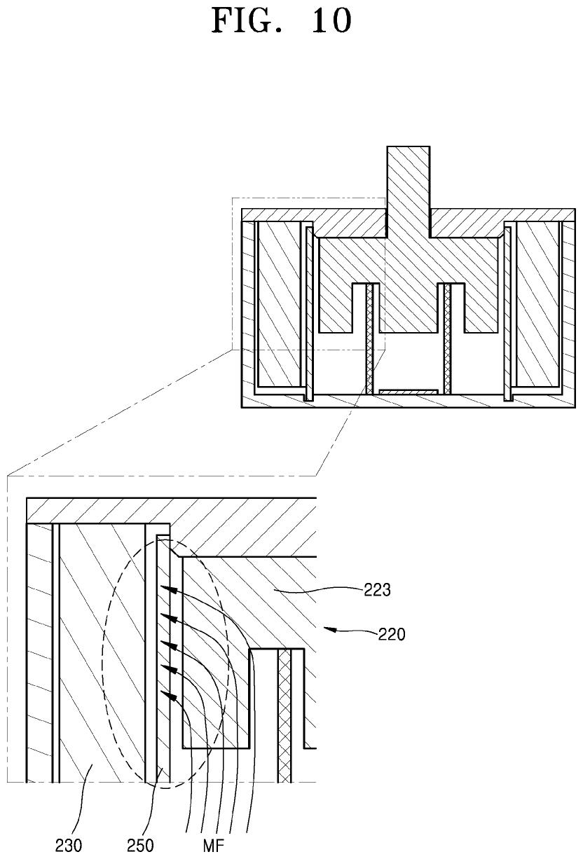

FIG. 9 is a schematic view showing operation of the haptic input device 200 according to the second embodiment of the present invention. FIG. 10 is a schematic view of a magnetic circuit of the haptic input device 200 according to the second embodiment of the present invention.

Referring to FIGS. 9 and 10, the magnetic circuit part 230 may be provided in a vertical direction (i.e., the Z-axis direction) along the side surfaces of the second case 215. A magnetic circuit may be formed roughly upward to pass through the central space R3 of the magnetic circuit part 230. The stopper 223 and the side parts 227 of the shaft 220, which may be made of a magnetic material, may also contribute to the formation of the magnetic flux lines MF in the vertical direction (i.e., the Z-axis direction). As shown in FIG. 10, the magnetic flux lines MF may form magnetic loops along an upper portion of the magnetic circuit part 230—the stopper 223 and the side parts 227—a lower portion of the magnetic circuit part 230.

As shown in FIG. 9, when the user applies the external force P to push the upper end 221 of the shaft 220, the shaft 220 presses the elastic part 240. When no magnetic field is applied and no magnetic flux lines MF are formed, the elastic part 240 may be pressed (240→240′) to provide the user with a repulsive force corresponding to its elastic force.

When a magnetic field is applied and the magnetic flux lines MF are formed, the magnetic particles in the magnetorheological fluid M may form magnetic chains (M→M′) in the direction of the magnetic flux lines MF. The magnetic chains may be formed roughly from the inner side wall of the second internal space R4 [or the yoke 250] where the magnetorheological fluid M is accommodated, to a side of the shaft 220. Alternatively, the magnetic chains may be formed from a side of the lower end 225 of the shaft 220 to sides of the side parts 227. Due to the formation of the magnetic chains by the magnetic flux lines MF, resistance may be applied to the Z-axis direction operation of the shaft 220. That is, the magnetic chains may be formed in the horizontal plane direction (i.e., the XY plane direction) perpendicular to the operation direction of the shaft 220, and resistance may be applied in the Z-axis operation direction of the shaft 220. The resistance force applied during Z-axis direction operation of the shaft 220 may vary depending on the strength of the magnetic field, the bonding force of the magnetic chains, or the like. The user may be provided with haptic feedback based on the form, pattern, or strength of resistance.

When the user releases the external force P and the magnetic circuit part 230 also releases the magnetic field, the shaft 220 may return upward due to the restoring force of the elastic part 240.

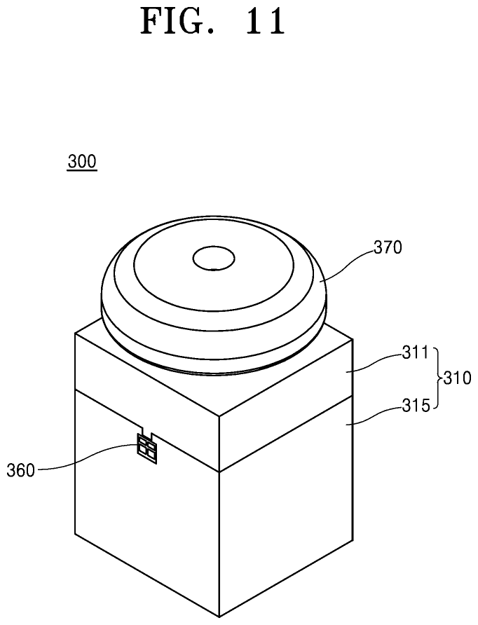

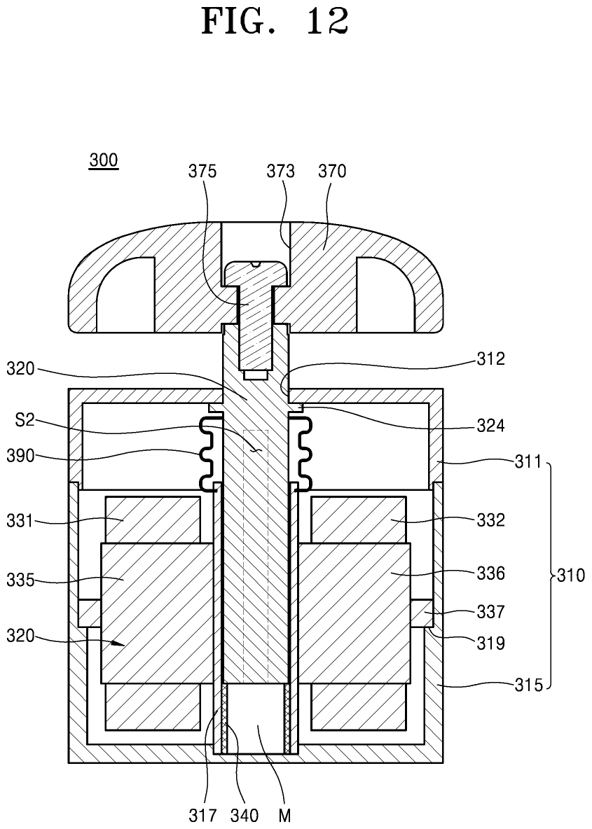

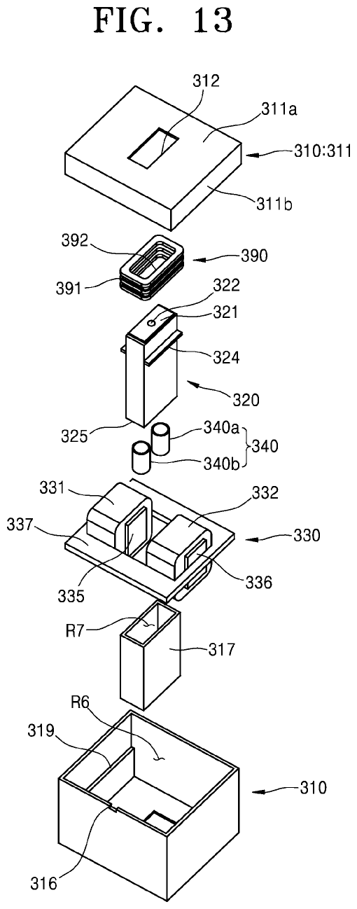

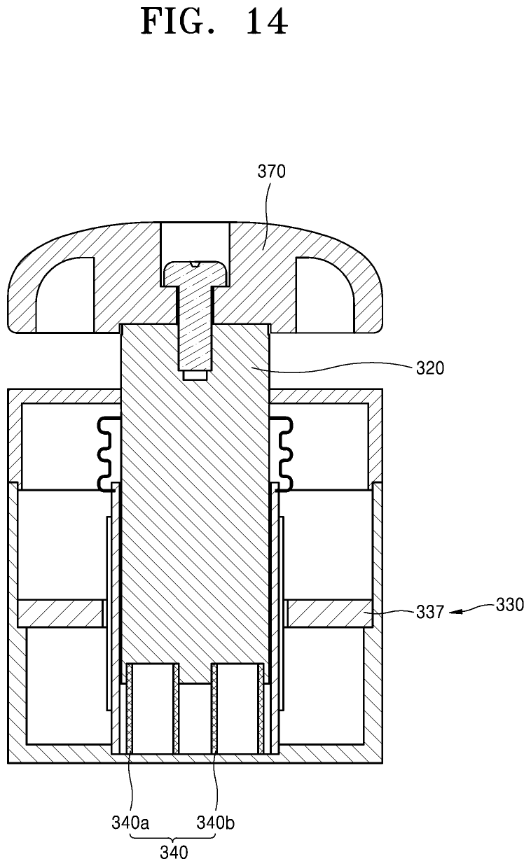

FIG. 11 is a perspective view of a haptic input device 300 according to a third embodiment of the present invention. FIG. 12 is a cross-sectional view of the haptic input device 300 according to the third embodiment of the present invention. FIG. 13 is an exploded perspective view of the haptic input device 300 according to the third embodiment of the present invention. FIG. 14 is another cross-sectional view of the haptic input device 300 according to the third embodiment of the present invention. Only elements that differ from those in the first embodiment of FIGS. 1 to 5 will be described below, and the same elements will not be repeated. The elements denoted by reference numerals 3XX in the third embodiment correspond to those denoted by reference numerals 1XX in the first embodiment. Unless stated otherwise, the descriptions of the elements provided above in relation to FIGS. 1 to 5 also apply to FIGS. 11 to 14.

Referring to FIGS. 11 to 14, the haptic input device 300 according to the third embodiment of the present invention may include a case 310: 311 and 315, a shaft 320, a magnetic circuit part 330, an elastic part 340, and a magnetorheological fluid M, and further include a controller 360 and a knob 370. The haptic input device 300 of the third embodiment is designed to increase the operation/resistance torque with only a minimal increase in size compared to the haptic input device 100 of the first embodiment.

The case 310: 311 and 315 is a housing of the haptic input device 300, and may provide an internal space R6 for storing other components. A first case 311 may be provided in a roughly cuboid shape with an open bottom and a shaft passage hole 312. A second case 315 may be provided in a roughly cuboid shape with an open top. A connection hole 316 through which the controller 360 may be electrically connected to the magnetic circuit part 330 may be formed in a side surface of the second case 315.

An accommodation part 317 may be provided in the internal space R6 of the second case 315. The accommodation part 317 may be provided in a tube or column shape with an open top, or in a tube or column shape with an open top and bottom. When the lower surface of the accommodation part 317 is replaced by the inner lower surface of the second case 315, the accommodation part 317 may be provided in a tube or column shape with an open top and bottom.

The accommodation part 317 may provide an accommodation space R7 in the same direction as an extension direction of the shaft 320 (i.e., the Z-axis direction). The accommodation space R7 of the accommodation part 317 may be provided to have a shape, i.e., an inner diameter, corresponding to the outer diameter of the shaft 320. Therefore, when the shaft 320 operates along the Z-axis direction, the shaft 320 may operate in the accommodation space R7 without any axial deviation. The accommodation space R7 may have a height less than a Z-axis direction length of a portion of the shaft 320 positioned in the internal space R6 of the case 310.

The magnetorheological fluid M may be filled in the accommodation space R7 of the accommodation part 317. In addition, the elastic part 340 may be positioned in the accommodation space R7 of the accommodation part 317. Optionally, a switch (not shown) may be further positioned in the accommodation space R7 of the accommodation part 317.

The shaft 320 is substantially the same as the shaft 120 of the first embodiment. In addition to this, a protector 390 may be positioned to surround the outer circumference of the shaft 320. The protector 390 may have an insertion hole 392, and the shaft 320 may be inserted into the insertion hole 392. The protector 390 may be made of an elastic material. The protector 390 may be made of an elastic material such as silicone, silicone rubber, rubber, or polymer, and more specifically, of silicone. The protector 390 may have at least folds 391. The protector 390 may have a vertical length that is variable due to the characteristics of the elastic material and the folds 391. When the protector 390 stretches in the Z-axis direction, the folds 391 may unfold, and when the protector 390 is contracted, additional folds 391 may be formed.

The protector 390 may be positioned under a stopper 324 provided on side surfaces of the shaft 320. The protector 390 may be positioned on the accommodation part 317. As such, the magnetorheological fluid M filled in the accommodation space R7 of the accommodation part 317 may be prevented from leaking outside the accommodation part 317.

To efficiently prevent the leakage of the magnetorheological fluid M, the outer circumference of the protector 390 may roughly correspond to the outer circumference of the accommodation part 317. The protector 390 may be provided in a tube or column shape with a hollow in the middle to correspond to the accommodation part 317.

A fluidic part S2 serving as a space where the magnetorheological fluid M is movable may be formed in the shaft 320. That is, another end of the shaft 320 excluding the space where the fluidic part S2 is formed may be used to press the elastic part 340.

The magnetic circuit part 330 may be provided to surround the shaft 320 in the internal space R6 of the case 310. Although it is shown in this specification that a first pole 331 and a second pole 332 are spaced apart from each other on left and right sides of the shaft 320, the first or second pole 331 or 332 may be selectively positioned on only one side of the shaft 320. Alternatively, a third pole may be further positioned on a side other than the left and right sides of the shaft 320.

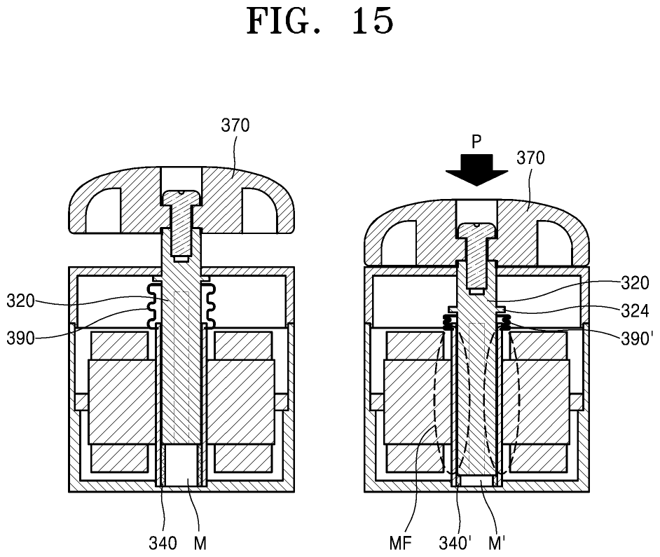

The first and second poles 331 and 332 may be provided to include coils and solenoid electromagnets. The first and second poles 331 and 332 may be wound with coils over the entirety of a vertical length of the internal space R6 to form magnetic flux lines MF [see FIG. 15] throughout a vertical direction of the internal space R6.

The first and second poles 331 and 332 may be fitted to a first core 335 and a second core 336, respectively. A magnetic frame 337 may be provided to electrically/magnetically interconnect the first and second cores 335 and 336. The magnetic frame 337 may serve as the outer edge of the magnetic circuit part 330. The magnetic frame 337 may be provided as a structure surrounding the outer sides of the first and second poles 331 and 332, and interconnecting the outer sides of the first and second cores 335 and 336.

The magnetic frame 337 may be provided parallel to the XY plane direction. The lower surface of the magnetic frame 337 may be supported on internal recesses 319 of the second case 315. By supporting the magnetic frame 337 on the internal recesses 319, the magnetic circuit part 330 may be stably positioned in the internal space R6.

Like the shaft 320, the magnetic frame 337 may include at least a magnetic portion. The first and second cores 335 and 336 may also include at least a magnetic portion. As such, the magnetic flux lines MF may be formed in the formation direction of the magnetic frame 337 (i.e., the XY plane direction) in addition to the vertical direction of the internal space R6 (i.e., the Z-axis direction). Because the magnetic flux lines MF are formed over a wider range in the internal space R6, the shaft 320 may be subjected to higher shear force, resistance force, torque, or changes in stiffness during Z-axis direction operation.

The elastic part 340 may be positioned in the accommodation space R7 of the accommodation part 317. One or more elastic parts 340 may be positioned in the accommodation space R7. For example, when the elastic part 340 is a cylindrical spring and an X-axis or Y-axis direction width of the accommodation space R7 is greater than a diameter of the elastic part 340, the elastic part 340 may unstably shake in the accommodation space R7. In this case, the unstable shake may be mitigated by positioning a plurality of elastic parts 340 in the accommodation space R7, parallel to the XY plane direction. Referring to FIG. 14, two elastic parts 340a and 340b may support lower left and right portions of the shaft 320, thereby preventing the shaft 320 from tilting or shaking during Z-axis direction operation. Meanwhile, to more stably position the elastic part 340 in the accommodation space R7, the elastic part 340 may be fitted or connected to the bottom of the accommodation part 317. In addition, the top of the elastic part 340 may be fitted or connected to the bottom of the shaft 320.

FIG. 15 is a schematic view showing operation of the haptic input device 300 according to the third embodiment of the present invention.

Referring to FIG. 15, the first and second poles 331 and 332 of the magnetic circuit part 330 may be provided along the vertical direction (i.e., the Z-axis direction) in the internal space R6. As such, the magnetic circuit [or the magnetic flux lines MF] may also be formed in the vertical direction to correspond to the formation direction of the magnetic circuit part 330. The shaft 320 and the magnetic frame 337, which may be made of a magnetic material, may also contribute to the formation of the magnetic flux lines MF in the horizontal plane direction. For example, as shown on the right side of FIG. 15, the magnetic flux lines MF may form magnetic loops along an upper portion of the first pole 331/second pole 332—the shaft 320 and the magnetic frame 337—a lower portion of the first pole 331 second pole 332.

As another example, when the first and second poles 331 and 332 have opposite polarities, the magnetic flux lines MF may form magnetic loops along an upper portion of the first pole 331—an upper portion of the second pole 332—a lower portion of the second pole 332—a lower portion of the first pole 331.

As shown in FIG. 15, when the user applies the external force P to push the shaft 320 [or the knob 370], the shaft 320 presses the elastic part 340. When no magnetic field is applied and no magnetic flux lines MF are formed, the elastic part 340 may be pressed (340→340′) to provide the user with a repulsive force corresponding to its elastic force.

When a magnetic field is applied and the magnetic flux lines MF are formed, the magnetic particles in the magnetorheological fluid M may form magnetic chains (M→M′) in the direction of the magnetic flux lines MF. The magnetic chains may be formed roughly from the inner side wall of the accommodation part 317 where the magnetorheological fluid M is accommodated, to a side of the shaft 320. Alternatively, the magnetic chains may be formed from a side of the shaft 320 to the inner side wall of the accommodation part 317 in the fluidic part S2 of the shaft 320. Due to the formation of the magnetic chains by the magnetic flux lines MF, resistance may be applied to the Z-axis direction operation of the shaft 320. That is, the magnetic chains may be formed in a direction parallel to the operation direction of the shaft 320 (i.e., the Z-axis direction) and the horizontal plane direction (i.e., the XY plane direction) perpendicular to the operation direction of the shaft 320, and resistance may be applied in the Z-axis operation direction of the shaft 320. The resistance force applied during Z-axis direction operation of the shaft 320 may vary depending on the strength of the magnetic field, the bonding force of the magnetic chains, or the like. The user may be provided with haptic feedback based on the form, pattern, or strength of resistance.

When the user releases the external force P and the magnetic circuit part 330 also releases the magnetic field, the shaft 320 may return upward due to the restoring force of the elastic part 340.

In addition, when the user applies the external force P, the stopper 324 of the shaft 320 may press the protector 390 (390→390′). Because the pressed protector 390′ still surrounds the outer circumference of the shaft 320, the magnetorheological fluid M may be prevented from leaking outside the accommodation part 317. When the user releases the external force P, the shaft 320 may return upward due to the restoring force of the elastic part 340 and the protector 390′ may stretch upward (390′→390) by unfolding the folds 391. The stretching of the protector 390 may add a force for pushing the stopper 324 upward, and the shaft 320 may return faster than when using only the elastic part 340.

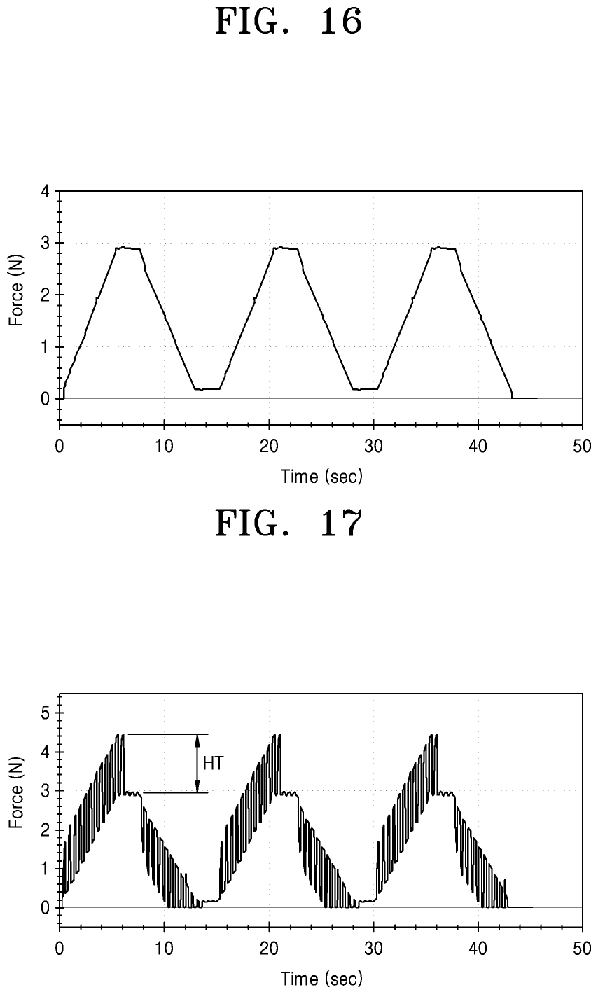

FIG. 16 is a no-load test graph of a haptic input device according to a test example of the present invention. FIG. 17 is a load test graph of a haptic input device according to a test example of the present invention. FIG. 16 shows the load size over time when no magnetic field is applied, and FIG. 17 shows the load size over time when a magnetic field is applied by a magnetic circuit part. The tests were conducted on the haptic input device 300, and the shaft 320 was operated in the Z-axis direction with a stroke of 5.0 mm three times. A load pattern of 2 Hz and 5 V was applied to the magnetic circuit part 330.

Referring to FIG. 16, when no magnetic field is applied, a force by resistance of the elastic part 340 is exhibited. Specifically, a resistance force of about 2.9 N is exhibited. Referring to FIG. 17, when a magnetic field is applied, in addition to the resistance force shown in FIG. 16, due to the formation of magnetic chains by the magnetorheological fluid M, the shaft 320 may be additionally subjected to shear force, resistance force, torque, or changes in stiffness during the Z-axis direction operation. The maximum resistance force in FIG. 17 is about 4.51 N, and the difference of about 1.61 N from about 2.9 N in FIG. 16 is an additional haptic force caused by the formation of magnetic chains by the magnetorheological fluid M. Furthermore, FIG. 17 shows that the user may be provided with a haptic force corresponding to a vibration pattern when the user pushes the shaft 320. Various patterns of haptic force may be provided depending on the magnetic field generated by the magnetic circuit part 330.

As described above, according to the present invention, haptic feedback may be provided to a user in various forms when input operation is performed through an input device.

According to the present invention, the haptic input device 100 or 200 may be easily implemented in a small size and thickness. According to an embodiment, the haptic input device 100 of the present invention may be produced in a width×length×thickness of about 20 mm×20 mm×13.5 mm excluding the knob 170, or about 20 mm×20 mm×22 mm including the knob 170. The operation stroke of the shaft 120 may be about 2.5 mm.

According to an embodiment, the haptic input device 200 of the present invention may be produced in about 8 mm×8 mm×4.8 mm excluding a knob with a height of about 1.5 mm, or about 8 mm×8 mm×6 mm including the knob. The operation stroke of the shaft 220 may be about 1.5 mm.

According to an embodiment, the haptic input device 300 of the present invention may be produced in a width×length×thickness of about 38 mm×40 mm×40 mm excluding the knob 370, or about 38 mm×40 mm×47.5 mm including the knob 370. The operation stroke of the shaft 320 may be about 5 mm.

According to an embodiment, haptic feedback may be provided with low energy by controlling resistance through the formation of magnetic chains by the magnetorheological fluid M in addition to the elastic force and restoring force of the elastic part 140, 240, or 340.

While the present invention has been particularly shown and described with reference to embodiments thereof, it will be understood by one of ordinary skill in the art that various changes in form and details may be made therein without departing from the scope of the present invention as defined by the following claims.

1. A haptic input device for providing haptic feedback to a user, the haptic input device comprising:
a case for providing an internal space;
a shaft having an end exposed outside, and another end located in the internal space of the case;
a magnetic circuit part positioned on at least one side of the shaft to form a magnetic circuit;
an elastic part contacting the other end of the shaft to provide a restoring force to the shaft; and
a magnetorheological fluid filled in at least a portion of the internal space.

2. The haptic input device of claim 1, further comprising a controller for controlling the magnetic circuit formed by the magnetic circuit part.

3. The haptic input device of claim 1, wherein the case comprises:
a first case positioned on top and having a shaft passage hole through which the shaft passes; and
a second case positioned on bottom to provide the internal space where the magnetorheological fluid is accommodated.

4. The haptic input device of claim 3, wherein the second case comprises an accommodation part where the magnetorheological fluid and the elastic part are accommodated.

5. The haptic input device of claim 4, wherein the magnetic circuit part is provided in an XY plane direction, and
wherein an end and another end of the magnetic circuit part are supported on the accommodation part and the second case and positioned in the internal space.

6. The haptic input device of claim 2, wherein the controller comprises:
a control circuit part; and
a control terminal for transmitting power to the control circuit part,
wherein the control circuit part is positioned in the internal space, and
wherein at least a portion of the control terminal is exposed outside the case.

7. The haptic input device of claim 1, wherein a knob is connected to the end of the shaft.

8. The haptic input device of claim 4, wherein a switch is further positioned in the accommodation part, and
wherein a pusher for pushing the switch protrudes from the other end of the shaft.

9. The haptic input device of claim 1, wherein the other end of the shaft comprises pressers for pressing at least the elastic part, and
wherein a fluidic part serving as a space where the magnetorheological fluid is movable is formed between the pressers.

10. The haptic input device of claim 3, wherein a stopper is provided on side surfaces of the shaft to restrict an operation range of the shaft to a lower surface of the shaft passage hole of the first case.

11. The haptic input device of claim 3, further comprising a yoke positioned in the internal space of the second case to provide a second internal space.

12. The haptic input device of claim 11, wherein the magnetorheological fluid is filled in the second internal space of the yoke, and
wherein the second internal space has an upper portion sealed by the first case and a lower portion sealed by the second case.

13. The haptic input device of claim 11, wherein the magnetic circuit part is positioned in a space between the yoke and the second case.

14. The haptic input device of claim 11, wherein the elastic part is positioned in the second internal space, and
wherein the other end of the shaft is inserted into the elastic part.

15. The haptic input device of claim 14, wherein a stopper is further provided on side surfaces of the shaft to have a width corresponding to a width of the second internal space, and
wherein inner side surfaces of the yoke guide the shaft to operate along a Z-axis direction in the second internal space.

16. The haptic input device of claim 15, wherein side parts further extend downward from ends of the stopper.

17. The haptic input device of claim 4, wherein a stopper is provided on side surfaces of the shaft, and
wherein the haptic input device further comprises a protector positioned under the stopper to surround an outer circumference of the shaft, and positioned on the accommodation part to prevent the magnetorheological fluid from leaking outside the accommodation part.

18. The haptic input device of claim 4, wherein a plurality of elastic parts are positioned in the accommodation part, parallel to an XY plane direction.

19. The haptic input device of claim 1, wherein the magnetic circuit part comprises:
first and second poles for generating a magnetic field;
a first core fitted to the first pole; and
a second core fitted to the second pole.

20. The haptic input device of claim 19, wherein the magnetic circuit part interconnects outer sides of the first and second cores, and further comprises a magnetic frame surrounding outer sides of the first and second poles.
